(19) United States
(12) Patent Application Publication
(10) Pub. No.: US 2007/0153944 A1
(43) Pub. Date: Jul. 5, 2007

(54) Frequency adjustment of wireless telecommunication device

(76) Inventors: Erik Olaf Kerstenbeck, Ramona, CA (US); Ivan Krivokapic, San Diego, CA (US); Michael Buyanin, San Diego, CA (US)

Correspondence Address: Hollingsworth & Funk, LLC;Suite 125, 8009 34th Avenue South, Minneapolis, MN, 55425, US

(21) Appl. No.: 11/321,266

(22) Filed: Dec. 29, 2005

(51) Int. Cl. H04L 27/06

(52) U.S. Cl. 375/344

(57) ABSTRACT

A system, a wireless telecommunication device, a method and a computer program are provided. The system comprises: a frequency generator for supplying a frequency reference for the wireless telecommunication device, the frequency generator further being configured to generate a first frequency and a second frequency simultaneously, the first frequency having a first response to the temperature of the frequency generator and the second frequency having a second response to the temperature of the frequency generator, the second response being different from the first response; a temperature parameter generator, connected to the frequency generator, configured to generate a temperature parameter proportional to the temperature of the frequency generator by using the first frequency and the second frequency; and a frequency controller configured to adjust the frequency reference on the basis of the temperature parameter.

### FIELD

The invention relates to a system for adjusting a frequency reference of a wireless telecommunication device, a wireless telecommunication device, and a method of adjusting a frequency reference in a wireless telecommunication device.

### BACKGROUND

With today's increasingly crowded communications spectrum, the need for high performance reference frequency generators of wireless telecommunication devices is increasing. Thermal effects in reference frequency generators give rise to instability in communication radio frequencies, thus reducing the overall performance of the wireless telecommunications system. Thermal stability may be improved by measuring the temperature of a reference frequency generator with a temperature sensor external to the reference frequency generator and by adjusting the frequency reference according to the temperature.

The use of an external temperature sensor, however, results in excess complexity of a temperature compensation system and inaccuracy in temperature compensation due to definite thermal conductivity between the frequency source and the temperature sensor. Therefore, it is desired to consider alternative techniques for adjusting a frequency reference of a wireless telecommunication device.

### BRIEF DESCRIPTION OF THE INVENTION

An object of the invention is to provide an improved system, a wireless device and a method for adjusting a frequency reference of a wireless telecommunication device.

According to a first aspect of the invention, there is provided a system for adjusting a frequency reference of a wireless telecommunication device, comprising: a frequency generator for supplying a frequency reference for the wireless telecommunication device, the frequency generator further being configured to generate a first frequency and a second frequency simultaneously, the first frequency having a first response to the temperature of the frequency generator and the second frequency having a second response to the temperature of the frequency generator, the second response being different from the first response; a temperature parameter generator, connected to the frequency generator, configured to generate a temperature parameter proportional to the temperature of the frequency generator by using the first frequency and the second frequency; and a frequency controller configured to adjust the frequency reference on the basis of the temperature parameter.

According to a second aspect of the invention, there is provided a system for adjusting a frequency reference of a wireless telecommunication device, comprising: a first generating means for generating, in a frequency generator supplying a frequency reference for the wireless telecommunication device, a first frequency and a second frequency simultaneously, the first frequency having a first response to the temperature of the frequency generator and the second frequency having a second response to the temperature of the frequency generator, the second response being different from the first response; a second generating means for generating a temperature parameter proportional to the temperature of the frequency generator by using the first frequency and the second frequency; and an adjusting means for adjusting the frequency reference on the basis of the temperature parameter.

According to a third aspect of the invention, there is provided a wireless telecommunication device comprising a frequency generator for supplying a frequency reference for the wireless telecommunication device, the frequency generator further being configured to generate a first frequency and a second frequency simultaneously, the first frequency having a first response to the temperature of the frequency generator and the second frequency having a second response to the temperature of the frequency generator, the second response being different from the first response; a temperature parameter generator, connected to the frequency generator, configured to generate a temperature parameter proportional to the temperature of the frequency generator by using the first frequency and the second frequency; and a frequency controller configured to adjust the frequency reference on the basis of the temperature parameter, wherein the frequency generator comprises an AT-cut crystal resonator configured to generate a fundamental frequency and a third overtone frequency, wherein the fundamental frequency is the first frequency and the third overtone frequency is the second frequency.

According to a fourth aspect of the invention, there is provided a wireless telecommunication device comprising a first generating means for generating, in a frequency generator supplying a frequency reference for the wireless telecommunication device, a first frequency and a second frequency simultaneously, the first frequency having a first response to the temperature of the frequency generator and the second frequency having a second response to the temperature of the frequency generator, the second response being different from the first response; a second generating means for generating a temperature parameter proportional to the temperature of the frequency generator by using the first frequency and the second frequency; and an adjusting means for adjusting the frequency reference on the basis of the temperature parameter.

According to a fifth aspect of the invention, there is provided a method of adjusting a frequency reference of a wireless telecommunication device: generating, in a frequency generator supplying a frequency reference for the wireless telecommunication device, a first frequency and a second frequency simultaneously, the first frequency having a first response to the temperature of the frequency generator and the second frequency having a second response to the temperature of the frequency generator, the second response being different from the first response; generating a temperature parameter proportional to the temperature of the frequency generator by using the first frequency and the second frequency; and adjusting the frequency reference on the basis of the temperature parameter.

The invention provides several advantages.

In an embodiment of the invention, the invention provides a self-sensing temperature determination based on different temperature responses of at least two oscillator modes of a frequency generator.

### LIST OF DRAWINGS

In the following, the invention will be described in greater detail with reference to the embodiments and the accompanying drawings, in which

FIG. 1 shows an example of a structure of a wireless telecommunication device;

FIG. 2 shows an example of a frequency adjustment system according to an embodiment of the invention;

FIG. 3 shows an example of a temperature response curve of a frequency generator;

FIG. 4 illustrates an example of a structure of a frequency controller;

FIG. 5 illustrates a first example of a methodology according to an embodiment of the invention, and

FIG. 6 illustrates a second example of a methodology according to an embodiment of the invention;

### DESCRIPTION OF EMBODIMENTS

With reference to FIG. 1, examine an example of a structure of a wireless telecommunication device (WTD) 100. The wireless telecommunication device 100 may also be referred to as a mobile phone, a cellular phone, user equipment, a mobile station, a mobile terminal and/or a wireless telecommunication modem. The present solution, is not, however, restricted to the listed devices, but may be applied to any wireless telecommunication device connectable to a wireless telecommunication network.

The wireless telecommunication network may be based on the following radio access technologies: GSM (Global System for Mobile Communications), GERAN (GSM/EDGE Radio access network), GPRS (General Packet Radio Service), E-GPRS (EDGE GPRS), UMTS (Universal Mobile Telecommunications System), CDMA2000 (CDMA, Code Division Multiple Access), US-TDMA (US Time Division Multiple Access) and TDS-CDMA (Time Division Synchronization CDMA). The invention is not, however, restricted to the listed radio access technologies, but may be applied to any wireless telecommunication device.

The wireless telecommunication device 100 includes a base band domain (BB) 102 and a radio frequency domain (RF) 130. The base band domain 102 comprises a digital signal processor (DSP) 104 and a memory unit (MEM) 106 connected to the digital signal processor 104.

The digital signal processor 104 and the memory unit 106 typically form a part of the computer of the cellular telecommunication device 100. The presented division of the wireless telecommunication device 100 into the base band domain 102 and the radio frequency domain 130 is provided for the ease of discussion and does not restrict embodiments of the invention to a divided structure.

The memory unit 106 may include following types of ROM (Read Only Memory): PROM (Programmable ROM), EPROM (erasable PROM), EEPROM (electrically erasable) or Flash EEPROM. RAM (Random Access Memory) may be also used for storage purposes during an execution of a computer software. RAM could be implemented with SRAM (Static RAM), DRAM (Dynamic RAM), SDRAM (Synchronous DRAM). Both ROM and RAM may be embedded into the digital signal processor 104.

The radio frequency domain 130 typically comprises a transceiver (TRX) 108 and an antenna 110 which together implement the radio interface of the wireless telecommunication network. The transceiver 108 includes a transmit chain not shown in FIG. 1 for transforming a base band transmit signal 128A into a radio frequency transmit signal 134A. The transmit chain comprises, for example, an up-converter for converting the base band transmit signal 128A into a radio frequency.

The transceiver 108 may also comprise a receive chain not illustrated in FIG. 1 for receiving a radio frequency receive signal 134B from the radio interface and for transforming the radio frequency receive signal 134B into a base band receive signal 128B. The receive chain comprises, for example, a down-converter for converting the radio frequency receive signal 134B into a base band frequency.

The radio frequency domain 130 further comprises a radio frequency synthesizer (RFS) 114, which generates a radio frequency signal 112 and feeds the radio frequency signal 112 into the transceiver 108. The radio frequency synthesizer 114 may comprise a phase-locked loop that is known as a feedback system for generating the radio frequency signal 112 with accurate and stable signal characteristics, such as frequency and phase.

The radio frequency synthesizer 114 is typically provided with a synthesizer control signal 126 by the digital signal processor 104. The synthesizer control signal 126 includes control information, such as a frequency multiplication factor applied by the phase locked loop, for adjusting the frequency of the radio frequency signal 112.

A wireless telecommunication device 100 may include a plurality of radio frequency synthesizers 114, each producing a different radio frequency for a down-converter and/or an up-converter. Furthermore, a radio frequency synthesizer 114 may be dedicated to generating intermediate frequencies in an intermediate frequency domain.

The radio frequency synthesizer 114 is provided with a reference frequency signal 116 by a reference frequency generator (RFG) 118. The frequency of the radio frequency signal 112 generated by the radio frequency synthesizer 114 is typically a multiple of the frequency reference 116, where the ratio of the frequency of the radio frequency signal 112 and the frequency reference 116 is controlled with the synthesizer control signal 126. Therefore, the characteristics of the frequency reference 116 affect the processing of the radio frequency transmit signal 134A and that of the radio frequency receive signal 134B, thus having an impact on the performance of the wireless telecommunication system.

In an embodiment of the invention, the reference frequency generator 118 comprises a voltage controlled temperature compensated crystal oscillator (VCTCXO) as a frequency generator or a voltage controlled crystal oscillator (VCXO).

The reference frequency generator 118 may receive frequency reference control signals 122 from the digital signal processor 104. The frequency reference control signals 122 may carry information, in a digital or analogue form, on a desired frequency reference 116. The frequency reference control signal 122 may include information on the control voltage which controls the voltage controlled temperature compensated crystal oscillator.

A digital-to-analogue converter (DAC) not shown in FIG. 1 may be located between the digital signal processor 104 and the reference frequency generator 118. The DAC may convert a digital frequency reference control signal 122 into an analogue frequency reference control signal 112, whose voltage adjusts a resonator structure of the reference frequency generator 118.

The frequency reference control signals 122 may contain a coarse adjustment portion and a fine adjustment portion. The coarse adjustment portion and the fine adjustment portion may be converted into analogue signals in a coarse DAC and a fine DAC, respectively, in order to obtain a large dynamic range in the adjustment of the frequency reference 116.

A coarse adjustment may be based on an automatic frequency control (AFC) system based on a frequency measurement carried out in the transceiver 108. The transceiver 108 receives a radio frequency reference, on a pilot channel, for example, from the infrastructure of the wireless telecommunication system and compares an internal radio frequency generated from the frequency reference with the radio frequency reference. Comparison results 132 may be inputted into the digital signal processor 104, which generates the coarse adjustment portion of the frequency reference control signal 122 accordingly. This procedure may also be referred to as frequency synchronization.

The reference frequency generator 118 generates a feedback signal 124, which is inputted into the digital signal processor 104. The feedback signal 124 may comprise a temperature parameter characterizing a response of the reference frequency generator 118 to the temperature of the reference frequency generator 118.

The wireless telecommunication device 100 may further include a user interface (UI) 120, which provides the user with means for communicating with the wireless telecommunication device 100. The user interface 120 may comprise an audiovisual interface and a keypad, for example.

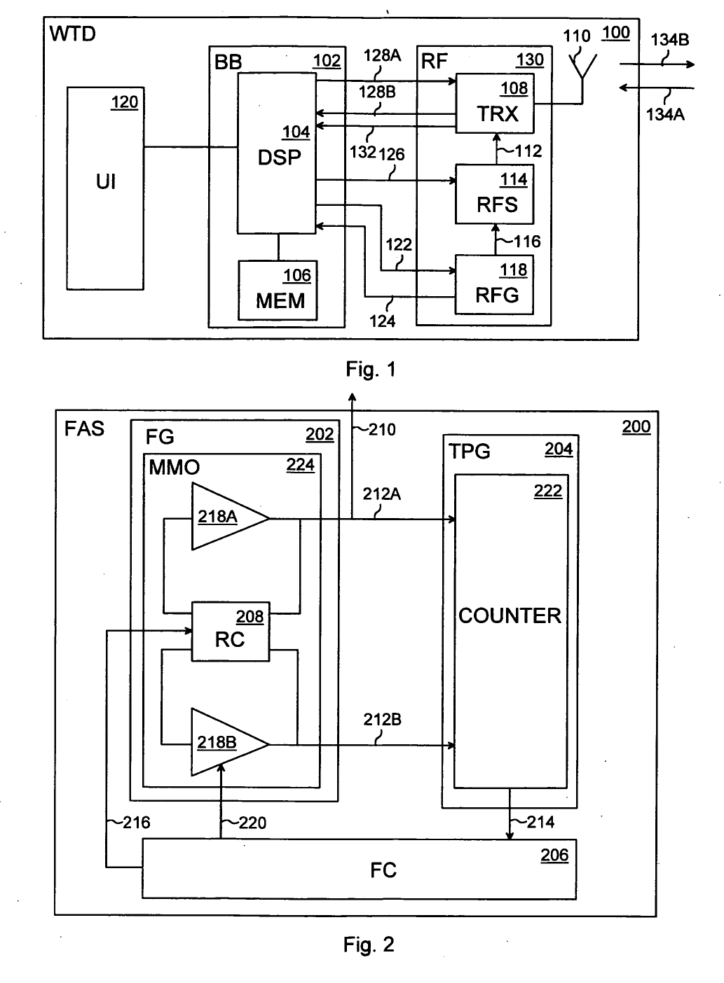

With reference to FIG. 2, a frequency adjustment system (FAS) 200 comprises a frequency generator (FG) 202, a temperature parameter generator (TPG) 204 connected to the frequency generator 202, and a frequency controller (FC) 206 operatively connected to the temperature parameter generator 204 and the frequency generator 202.

The frequency adjustment system 200 carries out a frequency adjustment procedure which compensates for temperature effects on the frequency reference.

The frequency generator 202 generates a first frequency 212A having a first response to the temperature of the frequency generator 202, and a second frequency 212B having a second response to the temperature of the frequency generator 202. The second response is different from the first response, which in this context means that there is a non-linear relation between the first response and the second response.

The frequency generator 202 outputs a frequency reference 210 referred to as the frequency reference 116 shown in FIG. 1. The frequency reference 210 may be the first frequency 212A, the second frequency 212B or another frequency proportional to the first frequency 212A or the second frequency 212B.

The first frequency 212A and the second frequency 212B are inputted into the temperature parameter generator 204, which generates a temperature parameter proportional to the temperature of the frequency generator 202 by using the first frequency 212A and the second frequency 212B.

The temperature parameter is incorporated into a feedback signal 214, which is inputted into the frequency controller 206.

In an embodiment of the invention, the temperature parameter generator 204 performs a comparison between the first frequency 212A and the second frequency 212B, and generates the temperature parameter on the basis of the comparison. As the first response differs from the second response, the comparison characterizes the temperature of the frequency generator 202.

The frequency controller 206 receives the temperature parameter and adjusts the frequency reference 210 on the basis of the temperature parameter. The frequency controller 206 generates a frequency reference control signal 216 and inputs the frequency reference control signal into the frequency generator 202.

The frequency reference control signal 216 corresponds to the frequency reference control signal 122 of FIG. 1. The frequency reference control signal 216 may include a control voltage adjusted to provide an adjustment for a crystal oscillator according to the temperature parameters. Alternatively, the frequency reference control signal may 216 contain information on a frequency adjustment according to the temperature parameter. In such a case, the frequency generator may include means, such as a digital-to-analogue converter, for converting the frequency adjustment into a quantity that realizes the adjustment in the frequency generator 202.

In an embodiment of the invention, the frequency generator 202 comprises a temperature-sensitive multi-mode oscillator (MMO) 224, such as a dual-mode oscillator, which generates simultaneously a fundamental frequency denoted f_{fun} a third overtone frequency denoted f₃ₒᵥₜ which in context correspond to the first frequency 212A and the second frequency 212B, respectively.

The multi-mode oscillator 224 comprises typically a resonator crystal (RC) 208 and oscillator blocks 218A, 218B. A first oscillator block 218A is configured to amplify the first frequency 212A while the second oscillator block 218B is configured to amplify the second frequency 212B.

The second oscillator block 218B may be provided with a control signal 220 which may switch off and on the second oscillator block 218B. When switched on, the second oscillator block 218B is active, and the frequency adjustment related to temperature compensation may take place. The frequency adjustment related to the temperature compensation may be carried out while the transceiver 108 is inactive.

In an embodiment of the invention, the frequency generator 202 comprises an AT-cut crystal resonator in the resonator circuit configured to generate the fundamental frequency f_{fun} and the third overtone frequency f₃ₒᵥᵣₜ. The AT-cut crystal resonator provides an inexpensive resonator structure suitable for wireless telecommunication device, whose manufacturing cost is a critical parameter. Characteristics of the AT-cut crystal provide an easy means for factory calibration of the multi-mode oscillator 224. The inflection point temperature of the AT-cut crystal is close to room temperature, thus enabling a simple initial selection of temperature a compensation curve.

the temperature response of an AT-cut crystal resonator may be characterized with a temperature response curve

$$\frac{Δ f}{f} = {a}_{1} ( T - {T}_{inf} ) + {{a}_{3} ( T - {T}_{inf} )}^{3} , \qquad ( 1 )$$

where f is a generated frequency at current temperature T, T_{inf} is the temperature in the inflection point of the AT-cut crystal resonator, Δf is the deviation of frequency f from an inflection point frequency, and a₁ and a₃ are parameters characterizing the AT-cut crystal resonator.

The temperature response of Equation (1), for example, characterizes a frequency adjustment applied to the frequency reference 210 in order to compensate for the temperature effects in the frequency generator 202.

An AT-crystal resonator is associated with a plurality of temperature response curves, each curve representing a temperature response at a specific cut angle.

The fundamental frequency f_{fun} and the third overtone frequency f₃ₒᵥₜᵣ are inputted into the temperature parameter generator 204, which compares the fundamental frequency f_{fun} and the third overtone frequency f₃ₒᵥₜᵣ. In an embodiment of the invention, the temperature parameter generator 204 determines the temperature parameter as a difference between the third overtone frequency f₃ₒᵥₜᵣ and three times the fundamental frequency 3f_{fun}. In this case, the temperature parameter may also be referred to as a beat frequency f_{b} written as
f_{b}∝3×f_{fun}−f₃ₒᵥᵣₜ (2)

When assuming a temperature response curve of the form of Equation (1), the deviation ΔT of the current temperature T from the inflection point temperature is nearly linearly proportional to the beat frequency, i.e.
ΔT=(T−T_{inf})=A×f_{b}. (3)
where A is a conversion parameter. Equation (3) shows that the beat frequency may be used as a measure of the temperature of the frequency generator 202, thus providing a self-sensing method of the temperature. As a consequence, an external thermometer is not required for determining the temperature of the frequency generator 202.

Relations (1) and (3) give rise to a relationship between the beat frequency and the temperature response, i.e.

$$\frac{Δ f}{f} = F ( {f}_{b} ) = {a}_{1} {Af}_{b} + {{a}_{3} ( {Af}_{b} )}^{3} , \qquad ( 4 )$$

where F(f_{b}) represents a generic dependence of the temperature response on the beat frequency.

The frequency generator 202 may be implemented with an RF ASIC (Application-Specific Integrated Circuit), such as a transmitter ASIC or receiver ASIC.

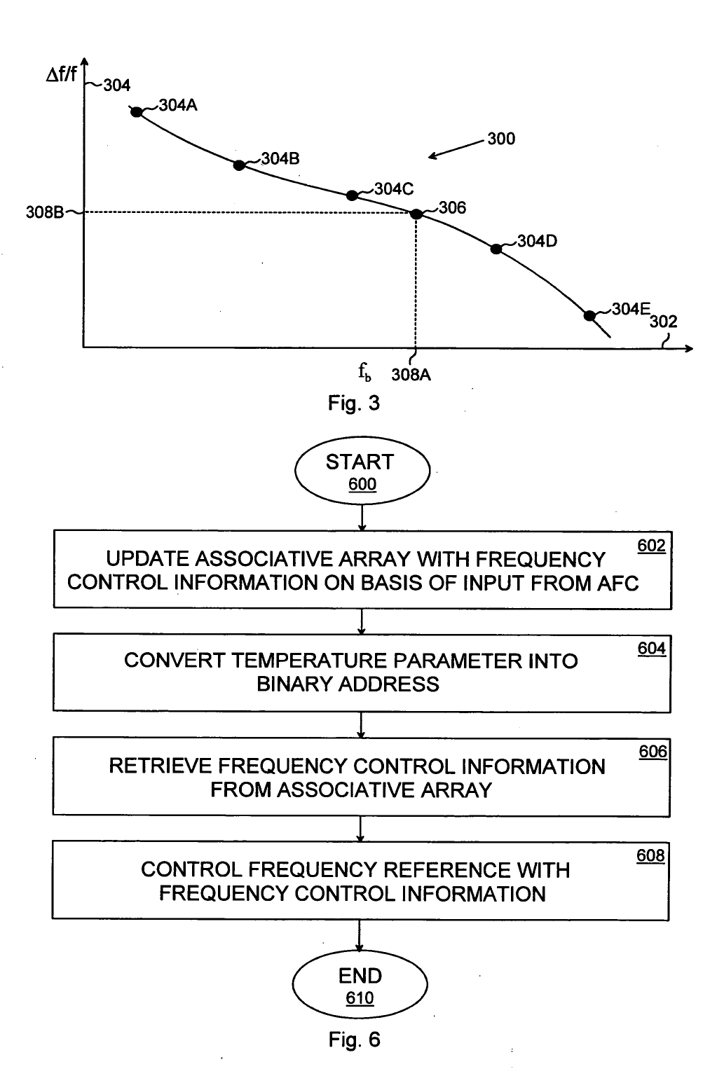

FIG. 3 shows an example of a temperature response curve 300. A horizontal axis 302 shows the temperature parameter, such as the beat frequency, while a vertical axis 304 shows frequency correction. Also, curve points 304A to 304E defining the response curve 300 are shown.

In an embodiment of the invention, the frequency controller 206 uses a linear model, such as that shown in Equation (3) between the temperature of the frequency generator 202 and the temperature parameter. The linear dependence may be used explicitly, i.e., the current temperature is determined explicitly, and the frequency adjustment is generated according to the current temperature value.

In an embodiment, the linear dependence between the temperature and the temperature parameter may be used implicitly. In such a case, the frequency adjustment is based on the temperature parameter, such as the beat frequency, and the linear dependence is assumed in the conversion between the temperature parameter and the content of the frequency reference control signal 216. In such a case, Equation (4) may be used.

The frequency controller 206 may be implemented with the digital signal processor 104 and a computer program executed in the digital signal processor 104 and stored in the memory unit 106. In some embodiments, the frequency controller 206 may comprise digital-to-analog converters, which convert the reference frequency control signal 216 from a digital format into an analogue format.

With further reference to FIG. 2, the temperature parameter generator 204 may comprise a counter 222, which generates the temperature parameter on the basis of a count of pulses associated with the first frequency 212A and pulses associated with the second frequency 212B. The counter 222 may be based on a down-count binary counter.

The down-count binary counter may utilize the first frequency 212A as a clock frequency. The down-count binary counter may be preloaded with initial value −3P, where P is a product of a counting period and the clock frequency. The down-count binary counter starts counting pulses associated with the third overtone frequency. Each pulse subtracts 1 from the preloaded value 3P. In the end of the counting period, the beat frequency is obtained as a difference between the preloaded value of 3P and the sum of the pulses associated with the third overtone frequency. The beat frequency is latched and made available to the frequency controller 206. In terms of a mathematical representation, the beat frequency may be written as

$${f}_{b} = \frac{1}{{T}_{c}} ( 3 P - {f}_{3 ovrt} {T}_{c} ) , \qquad ( 5 )$$

where T_{c} is the counting period.

The down-count binary counter may be implemented with a logical circuit and/or an algorithm executed in the digital signal processor 104.

The adjustment of the frequency reference 210 is typically realized with a control voltage applied to the resonator crystal 208 of the frequency generator 202. Thereby, the temperature response may be written as
ΔV_{T}=ΔV_{T}(f_{b}), (6)
where ΔV_{T} is the change in the control voltage as a function of the beat frequency. The control voltage of Equation (6) may represent the physical potential difference applied to the resonator crystal 208 or a value proportional to the control voltage before a digital-to-analogue conversion.

The temperature parameter generator 204 may be implemented with logical circuits and/or a DSP algorithm executed in the digital signal processor 104.

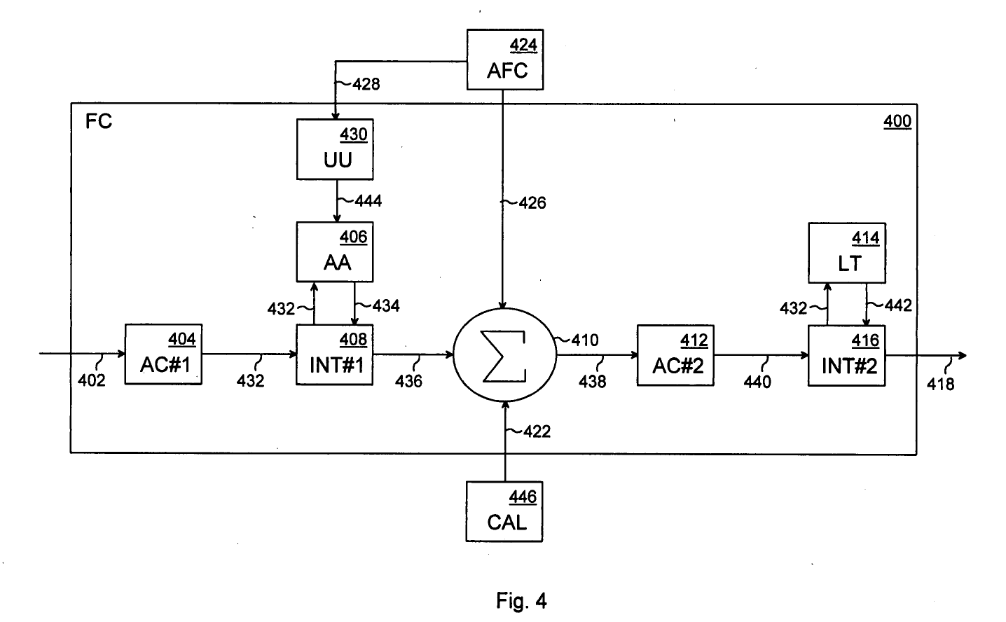

With reference to the example shown in FIG. 4, the frequency controller 400 comprises a first address converter (AC#1) 404, an associative array (AA) 406, a first interpolator (INT#1) 408, a summing junction 410, a second address converter (AC#2) 412, a linearization table (LT) 414, a second interpolator (INT#2) 416 and an updating unit (UU) 430. FIG. 4 further shows an automatic frequency control system (AFC) 424 connected to the frequency controller 400.

The first address converter 404 receives the temperature parameter 402, such as the beat frequency, from the temperature parameter generator 204. The first address converter 404 converts the temperature parameter 402 into a binary address 432 pointing to the associative array 406.

The first address converter 404 may be implemented with an algorithm executed in the digital signal processor 104.

The binary address 432 corresponding to the temperature parameter 402 is retrieved from the first address converter 404 and inputted into the associative array 406. The associative array 406 comprises frequency control information, each piece of the frequency control information associated with a binary address 432. The associative array 406 may include curve points 304A to 304E of the temperature response curve 300, where the temperature parameter 402 is represented by the binary address 432.

The frequency controller 400 retrieves the piece of frequency control information 434 corresponding to the temperature parameter from the associative array 406.

The associative array 406 may be stored in the memory unit 106 of the wireless telecommunication device 100. In an embodiment, the associative array 406 is downloaded into the cache of the digital signal processor 104 before the start of the frequency adjustment procedure.

In an embodiment of the invention, the binary address 432 is inputted into the first interpolator 408, which tests whether or not the binary address 432 and the corresponding piece of control information are available in the associative array 406. An example of the binary address 308A and the corresponding piece of control information 308B is shown as a curve point 306 in FIG. 3. If the binary address 308A and the corresponding piece of control information 308B are not available, the first interpolator 408 may retrieve curve points 304A to 304B in the proximity of the curve point 306 from the associative array 406 and determine the missing curve point 306 by using the available curve points 304A to 304E and an interpolation procedure, such as linear interpolation or spline interpolation.

The interpolator 408 generates a frequency control sequence 436 based on either a direct access or an interpolation and inputs the control sequence into the summing junction 410. The summing junction 410 may be provided with AFC control information 426 by the automatic frequency control 424. The AFC control information 426 may include information from the automatic frequency control procedure and control information relating to the aging of the resonator crystal 208, for example.

The summing junction 410 may also be provided with calibration information 422 relating to frequency offsets of the resonator crystal 208. The calibration information 422 may be generated in a calibration unit 446 connected to the frequency generator 400. The calibration information 422 typically comprises a temperature dependent calibration factor and a temperature independent calibration factor.

The summing junction 410 sums the frequency control sequence 436 with the AFC control information 426 and the calibration information 422 and inputs a resulting sum sequence 438 into the second address converter 412. The sum sequence 438 includes frequency control information relating to, for example, the adjustment relating to the temperature effects in the resonator crystal 208, the frequency adjustment required by the automatic frequency control and the frequency adjustment required by the calibration of the frequency generator 202. Coarse temperature compensation is used to compensate for large frequency offsets that could not be covered by fine temperature/frequency offset compensation DAC.

The second address converter 412 converts the sum sequence 438 into a secondary binary address 440, which is inputted into a linearization table 414. The linearization table 414 includes pre-corrected control voltage values 442 which account for the non-linear frequency response of the frequency generator 202 to the control voltage.

In an embodiment of the invention, the second interpolator 416 tests whether or not a pre-corrected control voltage value corresponding to the secondary binary address 440 is available.

If the pre-corrected control voltage value 442 corresponding to the secondary binary address 440 is available, the interpolator 416 retrieves the pre-corrected control voltage value 442 and outputs the pre-corrected control voltage value 418 into the frequency generator 202 directly or via a controller controlling the frequency generator 202.

If the pre-corrected control voltage value 442 corresponding to the secondary binary address 440 is not available, the interpolator 416 retrieves pre-corrected control voltage values 442 from the linearization table 414 and determines a desired pre-corrected control voltage 418 value with an interpolation procedure.

The updating unit 430 updates the associative array 406 with calibration information 444 on the basis of an input 428 from an automatic frequency control 424.

The calibration information 444 comprises a temperature dependent calibration factor and a temperature independent calibration factor.

After turning on a non-calibrated wireless telecommunication device 100, a frequency offset will be defined by equation

$$\frac{Δ {f}_{{\sum }_{1}}}{{f}_{\sum }} = {α}_{1} ΔφΔ {T}_{1} + {a}_{3} Δ {T}_{1}^{3} + C , \qquad ( 7 )$$

where

$$\frac{Δ {f}_{{\sum }_{1}}}{{f}_{\sum }}$$

is a frequency offset at temperature T₁, Δφ is a resonator angular offset, and C is the temperature independent calibration factor.

After a rise in the temperature of the wireless telecommunication device 100, the frequency offset will be defined by

$$\frac{Δ {f}_{{\sum }_{2}}}{{f}_{\sum }} {α}_{1} ΔφΔ {T}_{2} + {a}_{3} Δ {T}_{2}^{3} + C , \qquad ( 8 )$$

where

$$\frac{Δ {f}_{{\sum }_{1}}}{{f}_{\sum }}$$

is a frequency offset at temperature T₂.

An unmodulated CW (continuous wave) frequency reference may be generated on a frequency channel with which the wireless telecommunication device is to be synchronized. The frequency reference will generate an offset response equal to the offset between the frequency reference and an internal reference scaled by the PLL multiplication factor. An FFT (Fast Fourier Transform) algorithm in the wireless telecommunication device 100 may be executed in order to determine frequency offset values. An alternative implementation for determining the frequency offsets is based on a CW tone generated by the wireless telecommunication device 100 on a particular frequency. Frequency offset from the desired frequency could be determined then by means of a spectrum analyzer.

The resonator angular offset Δφ may be determined by combining Equations (7) and (8), thus resulting in expression

$$Δφ = \frac{1}{{α}_{1} ( Δ {T}_{2} - Δ {T}_{1} )} ( \frac{Δ {f}_{{\sum }_{2}}}{{f}_{\sum }} - \frac{Δ {f}_{{\sum }_{1}}}{{f}_{\sum } } - {a}_{3} ( Δ {T}_{2}^{3} - Δ {T}_{1}^{3} ) ) . \qquad ( 9 )$$

In the proximity of the temperature inflection point where a calibration process usually takes place, Equation (9) may be simplified to

$$Δφ \approx \frac{1}{{α}_{1} ( Δ {T}_{2} - Δ {T}_{1} )} ( \frac{Δ {f}_{{\sum }_{2}}}{{f}_{\sum }} - \frac{Δ {f}_{{\sum }_{1}}}{{f}_{\sum }} ) \qquad ( 10 )$$

Equation (10) may further be simplified with form

$$Δφ = 3 ɛ \frac{( Δ {f}_{{\sum }_{2}} - Δ {f}_{{\sum }_{1}} )}{( Δ {f}_{b 2} - Δ {f}_{b 1} )} = 3 ɛ \frac{Δ ( Δ {f}_{\sum } )}{Δ ( Δ {f}_{b} )} = 3 ɛ \frac{{Δ}^{2} {f}_{\sum }}{{Δ}^{2} {f}_{b}} \qquad ( 11 )$$

where Δf_{b1} and Δf_{b2} are differences of the beat frequencies between an inflection point beat frequency.

In the proximity of the inflection point, it can be written

$$\frac{Δ {f}_{fun}}{{f}_{fun}} \approx Δ φ \frac{Δ {f}_{b}}{3 ɛ {f}_{fun}} , \qquad ( 12 )$$

where ε is the angular difference between the fundamental mode and the third overtone mode. By adopting Equation

$$\frac{Δ {f}_{b}}{{f}_{fun}} \approx \frac{Δ {f}_{b}}{{f}_{Σ}} , \qquad ( 13 )$$

the following expression is valid for the measured temperature offset:

$$\frac{Δ {f}_{Σ}}{{f}_{Σ}} \approx Δ φ \frac{Δ {f}_{b}}{3 ɛ {f}_{Σ}} + C . \qquad ( 14 )$$

By using the previous formulation, the temperature independent calibration factor may be written as

$$C = \frac{Δ {f}_{Σ}}{{f}_{Σ}} - \frac{Δ {f}_{fun}}{{f}_{fun}} . \qquad ( 15 )$$

Sufficient information for the frequency calibration may be acquired by determining the temperature compensation curve from Equation (11) and temperature independent calibration factor from Equation (15). The calibration may be realized by updating the associative array 406 with compensation curve points 304A-304E and the calibration unit 446 with calibration information.

During an active receive/transmit mode of the wireless telecommunication device 100, a temperature compensation mode is off, and the automatic frequency control 424 is responsible for the frequency control. When the wireless telecommunication device 100 is switched to an inactive receive/transmit mode, the frequency adjustment system 200 of FIG. 2 is activated with control signal 220. The automatic frequency control 424 may further incorporate aging compensation due to resonator aging.

After an active receive/transmit mode, the automatic frequency control 424 includes updated AFC control information, such as a shift of the control voltage. The updated AFC control information may be inputted into the updating unit 430 in the input 428 according to which the updating unit 430 generates the calibration information 444. The updating unit 430 may, for example, compare the updated AFC control voltage with the control voltage 434 at an arbitrary temperature point and to correct control voltage 434 such that the control voltage 434 provided by the associative array 406 accounts for the current AFC control voltage. The calibration may be applied to the entire calibration curve 300.

With further reference to FIG. 4, the first address converter 404 may be implemented, for example, with the digital signal processor 104 and coded instructions executed by the digital signal processor 104 and stored in the memory unit 106.

The first interpolator 408 may be implemented, for example, with the digital signal processor 104 and coded instructions executed by the digital signal processor 104 and stored in the memory unit 106.

The associative array may be implemented, for example, with the memory unit 106 or the cache of the digital signal processor 104.

The summing junction 410 may be implemented, for example, with the digital signal processor 104 and coded instructions executed by the digital signal processor 104 and stored in the memory unit 106.

The second address converter 412 may be implemented, for example, with the digital signal processor 104 and coded instructions executed by the digital signal processor 104 and stored in the memory unit 106.

The second interpolator 416 may be implemented, for example, with the digital signal processor 104 and coded instructions executed by the digital signal processor 104 and stored in the memory unit 106.

The linearization table 414 may be implemented, for example, with the memory unit 106 or the cache of the digital signal processor 104.

The updating unit 430 may be implemented, for example, with the digital signal processor 104 and coded instructions executed by the digital signal processor 104 and stored in the memory unit 106.

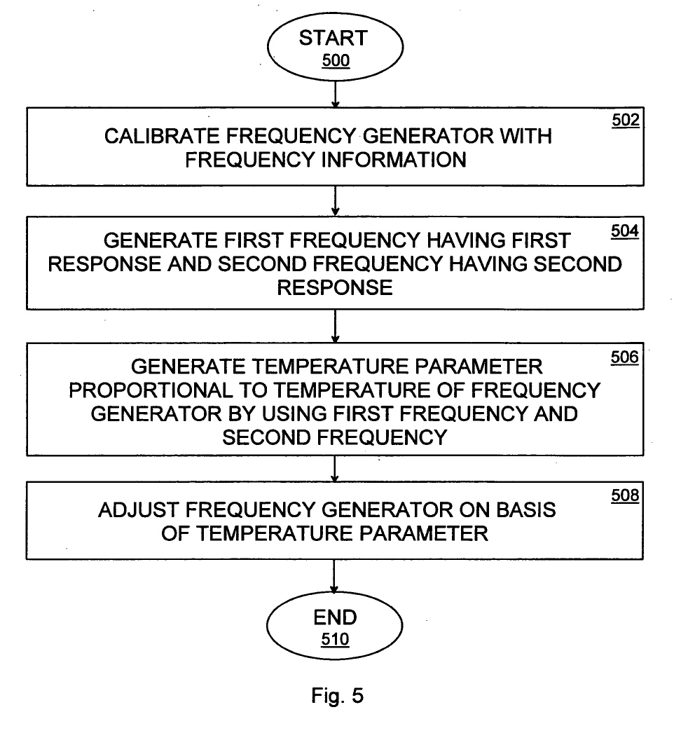

With reference to FIG. 5, a first example of the methodology according to embodiments of the invention is illustrated with a flow chart.

In 500, the method starts.

In 502, a frequency generator 202 is calibrated with calibration information 422 comprising a temperature dependent calibration factor and a temperature independent calibration factor.

In 504, a first frequency 212A and a second frequency 212B are generated simultaneously in a frequency generator 202 supplying a frequency reference 210 for the wireless telecommunication device 100, the first frequency 212A having a first response to the temperature of the frequency generator 202 and the second frequency 212B having a second response to the temperature of the frequency generator 202, the second response being different from the first response.

In an embodiment of the invention, a fundamental frequency and a third overtone frequency are generated in an AT-cut crystal resonator, wherein the fundamental frequency is the first frequency and the third overtone frequency is the second frequency.

In 506, a temperature parameter 402 proportional to the temperature of the frequency generator 202 is generated by using the first frequency 212A and the second frequency 212B.

In an embodiment of the invention, the temperature parameter 402 is determined as a difference between the third overtone frequency and three times the fundamental frequency.

In an embodiment of the invention, the temperature parameter 402 is generated on the basis of a count of pulses associated with the first frequency 212A and pulses associated with the second frequency 212B.

In 508, the frequency reference 210 is adjusted on the basis of the temperature parameter 402.

In an embodiment of the invention, a linear model between the temperature of the frequency generator 202 and the temperature parameter 402 is used when adjusting the frequency reference 210.

In 510, the method ends.

With reference to FIG. 6, a second example of the methodology according to embodiments of the invention is illustrated with a flow chart.

In 600, the method starts.

In 602, an associative array 406 is calibrated with calibration information 444 on the basis of an input 428 from an automatic frequency control 424 of the wireless telecommunication device 100.

In 604, a temperature parameter 402 is converted into a binary address 432.

In 606, frequency control information 434 is retrieved from the associative array 406, the frequency control information comprising pieces of frequency control information, each piece of the frequency control information being associated with a binary address 432.

In 608, the frequency reference 210 is controlled with the frequency control information.

In 610, the method ends.

The adjustment of the frequency reference 210 may be implemented with a computer program encoding a computer program of instructions for executing a computer process for adjusting 508 the frequency reference 210 on the basis of the temperature parameter 402.

The computer program may be comprised in a computer program product.

The computer program may be stored in a computer program distribution medium readable by a computer or a processor. The computer program medium may be, for example but not limited to, an electric, magnetic, optical, infrared or semiconductor system, device or transmission medium. The distribution medium may include at least one of the following media: a computer readable medium, a program storage medium, a record medium, a computer readable memory, a random access memory, an erasable programmable read-only memory, a computer readable software distribution package, a computer readable signal, a computer readable telecommunications signal, computer readable printed matter, and a computer readable compressed software package.

Even though the invention has been described above with reference to an example according to the accompanying drawings, it is clear that the invention is not restricted thereto but it can be modified in several ways within the scope of the appended claims.

1. A system for adjusting a frequency reference of a wireless telecommunication device, comprising:
a frequency generator for supplying a frequency reference for the wireless telecommunication device, the frequency generator further being configured to generate a first frequency and a second frequency simultaneously, the first frequency having a first response to the temperature of the frequency generator and the second frequency having a second response to the temperature of the frequency generator, the second response being different from the first response;
a temperature parameter generator, connected to the frequency generator, configured to generate a temperature parameter proportional to the temperature of the frequency generator by using the first frequency and the second frequency; and
a frequency controller configured to adjust the frequency reference on the basis of the temperature parameter.

2. The system of claim 1, wherein the frequency generator comprises an AT-cut crystal resonator configured to generate a fundamental frequency and a third overtone frequency, wherein the fundamental frequency is the first frequency and the third overtone frequency is the second frequency.

3. The system of claim 2, wherein the temperature parameter generator is configured to determine the temperature parameter as a difference between the third overtone frequency and three times the fundamental frequency; and
the frequency controller is configured to use a linear model between the temperature of the frequency generator and the temperature parameter.

4. The system of claim 1, wherein the frequency controller comprises:
an address converter for converting the temperature parameter into a binary address;
an associative array comprising pieces of frequency control information, each piece of the frequency control information associated with a binary address; and
the frequency controller is configured to retrieve frequency control information from the associative array and control the frequency reference with the frequency control information.

5. The system of claim 4, further comprising an updating unit configured to update the associative array with frequency control information on the basis of an input from an automatic frequency control of the wireless telecommunication device.

6. The system of claim 1, wherein the temperature parameter generator comprises a counter configured to generate the temperature parameter on the basis of a count of pulses associated with the first frequency and pulses associated with the second frequency.

7. The system of claim 1, further comprising a calibration unit configured to calibrate the frequency generator with calibration information, the calibration information comprising a temperature dependent calibration factor and a temperature independent calibration factor.

8. A system for adjusting a frequency reference of a wireless telecommunication device, comprising:
a first generating means for generating, in a frequency generator supplying a frequency reference for the wireless telecommunication device, a first frequency and a second frequency simultaneously, the first frequency having a first response to the temperature of the frequency generator and the second frequency having a second response to the temperature of the frequency generator, the second response being different from the first response;
a second generating means for generating a temperature parameter proportional to the temperature of the frequency generator by using the first frequency and the second frequency; and
an adjusting means for adjusting the frequency reference on the basis of the temperature parameter.

9. A wireless telecommunication device comprising:
a frequency generator for supplying a frequency reference for the wireless telecommunication device, the frequency generator further being configured to generate a first frequency and a second frequency simultaneously, the first frequency having a first response to the temperature of the frequency generator and the second frequency having a second response to the temperature of the frequency generator, the second response being different from the first response;
a temperature parameter generator, connected to the frequency generator, configured to generate a temperature parameter proportional to the temperature of the frequency generator by using the first frequency and the second frequency; and
a frequency controller configured to adjust the frequency reference on the basis of the temperature parameter, wherein the frequency generator comprises an AT-cut crystal resonator configured to generate a fundamental frequency and a third overtone frequency, wherein the fundamental frequency is the first frequency and the third overtone frequency is the second frequency.

10. The wireless telecommunication device of claim 9, wherein the temperature parameter generator is configured to determine the temperature parameter as a difference between the third overtone frequency and three times the fundamental frequency; and
the frequency controller is configured to use a linear model between the temperature of the of the frequency generator and the temperature parameter.

11. The wireless telecommunication device of claim 9, wherein the frequency controller comprises:
an address converter for converting the temperature parameter into a binary address;
an associative array comprising pieces of frequency control information, each piece of the frequency control information associated with a binary address; and
the frequency controller is configured to retrieve frequency control information from the associative array and control the frequency reference with the control information.

12. A wireless telecommunication device comprising:
a first generating means for generating, in a frequency generator supplying a frequency reference for the wireless telecommunication device, a first frequency and a second frequency simultaneously, the first frequency having a first response to the temperature of the frequency generator and the second frequency having a second response to the temperature of the frequency generator, the second response being different from the first response;
a second generating means for generating a temperature parameter proportional to the temperature of the frequency generator by using the first frequency and the second frequency; and
an adjusting means for adjusting the frequency reference on the basis of the temperature parameter.

13. A method of adjusting a frequency reference of a wireless telecommunication device, the method comprising:
generating, in a frequency generator supplying a frequency reference for the wireless telecommunication device, a first frequency and a second frequency simultaneously, the first frequency having a first response to the temperature of the frequency generator and the second frequency having a second response to the temperature of the frequency generator, the second response being different from the first response;
generating a temperature parameter proportional to the temperature of the frequency generator by using the first frequency and the second frequency; and
adjusting the frequency reference on the basis of the temperature parameter.

14. The method of claim 13, wherein the step of generating the first frequency and the second frequency comprises generating a fundamental frequency and a third overtone frequency in an AT-cut crystal resonator, wherein the fundamental frequency is the first frequency and the third overtone frequency is the second frequency.

15. The method of claim 13, wherein the step of generating the temperature parameter comprises determining the temperature parameter as a difference between the third overtone frequency and three times the fundamental frequency; and
wherein the step of adjusting comprises using a linear model between the temperature of the frequency generator and the temperature parameter.

16. The method of claim 15, wherein the step of adjusting comprises:
converting the temperature parameter into a binary address; and
retrieving frequency control information from an associative array, the frequency control information comprising pieces of frequency control information, each piece of the frequency control information associated with a binary address; and:
controlling the frequency reference with the frequency control information.

17. The method of claim 16, further comprising updating the associative array with frequency control information on the basis of an input from an automatic frequency control of the wireless telecommunication device.

18. The method of claim 13, wherein the step of generating the temperature parameter comprises generating the temperature parameter on the basis of a count of pulses associated with the first frequency and pulses associated with the second frequency.

19. The method of claim 13, further comprising calibrating the frequency generator with calibration information, the calibration information comprising a temperature dependent calibration factor and a temperature independent calibration factor.

20. A computer program of claim 13, the computer program encoding a computer program of instructions for executing a computer process for adjusting the frequency reference on the basis of the temperature parameter.

21. A computer program product of claim 20, wherein the computer program product comprises the computer program.

22. A computer program distribution medium of claim 20, wherein the computer program distribution medium is readable by a computer and comprises the computer program.
